(19) United States
(12) Patent Application Publication
(10) Pub. No.: US 2013/0017749 A1
(43) Pub. Date: Jan. 17, 2013

(54) SYSTEMS AND METHODS FOR MANUFACTURING FIBERS WITH ENHANCED THERMAL PERFORMANCE

(71) Applicants: Manoj Kumar Choudhary, Reynoldsburg, OH (US); Russell Potter, Hebron, OH (US)

(72) Inventors: Manoj Kumar Choudhary, Reynoldsburg, OH (US); Russell Potter, Hebron, OH (US)

(73) Assignee: OWENS CORNING INTELLECTUAL CAPITAL LLC, Toeldo, OH (US)

(21) Appl. No.: 13/547,408

(22) Filed: Jul. 12, 2012

Related U.S. Application Data
(60) Provisional application No. 61/506,862, filed on Jul. 12, 2011.

(51) Int. Cl. C03C 13/06; E04B 1/62; C03C 13/02; C03B 37/04; C03B 7/02

(52) U.S. Cl. 442/380; 65/376; 65/470; 442/414; 65/483

(57) ABSTRACT

In a method of producing fibers having property enhancing inclusions, a molten material is supplied to a fiber forming apparatus. A controlled amount of particulate is added to the molten material. The molten material with the added particulate is formed into fibers. An undissolved portion of the added particulate forms inclusions in the fibers, the inclusions having an absorption index in a 2-7 μm wavelength region that is greater than a corresponding absorption index of the material.

### CROSS-REFERENCE TO RELATED APPLICATION

The present application claims priority from U.S. Provisional Application Ser. No. 61/506,862 entitled “SYSTEMS AND METHODS FOR MANUFACTURING FIBERS WITH ENHANCED THERMAL RESISTANCE,” filed on Jul. 12, 2011, the entire disclosure of which is fully incorporated herein by reference.

### BACKGROUND

One measure of the effectiveness of fiberglass insulation is its attenuation of thermal radiation to which the insulation is exposed. The thermal performance of fiberglass insulation (for example, a fiberglass batt) is commonly enhanced by increasing the thickness of the insulation and/or by increasing the density of the insulation, both of which may result in added costs of insulation materials. Further, the amount of insulation material that may be used may be further limited by the size of the cavity in which the insulation material is installed.

### SUMMARY

According to an exemplary method of producing fibers having property enhancing inclusions, a molten material is supplied to a fiber forming apparatus. A controlled amount of particulate is added to the molten material. The molten material with the added particulate is formed into fibers. An undissolved portion of the added particulate forms inclusions in the fibers, the inclusions having an absorption index in a 2-7 μm wavelength region that is greater than a corresponding absorption index of the material.

According to another exemplary embodiment, a glass fiber suitable for insulation includes a glass material and a plurality of inclusions within the glass material. The plurality of inclusions have an absorption index in a 2-7 μm wavelength region that is greater than a corresponding absorption index of the material.

According to another exemplary embodiment, a fiberglass insulation product includes a plurality of glass fibers comprising a glass material and a plurality of inclusions within the glass material. The plurality of inclusions have an absorption index in a 2-7 μm wavelength region that is greater than a corresponding absorption index of the material.

According to still another exemplary embodiment, a fiberizer assembly includes a spinner, a forehearth, a burner, and a blower. The spinner includes an orificed peripheral wall through which molten mineral material passes to form mineral fibers. The forehearth supplies molten material to the spinner through a delivery tube. The burner is positioned to direct hot gases toward the peripheral wall of the spinner. The blower is positioned to attenuate fiber materials exiting orifices in the peripheral wall. A particulate source is connected with a particulate supply port and configured to supply a controlled amount of particulate to the molten material before the molten material passes through the peripheral wall orifices.

According to another exemplary embodiment, a fiber forming apparatus includes a molten mineral collection portion, a fiber formation portion, a fiber dispensing port, a particulate source, and a particulate supply port. The molten mineral collection portion is configured to receive a molten mineral material. The fiber formation portion is connected with the molten mineral collection portion and is configured to produce solid fibers from the molten mineral material. The fiber dispensing port is in communication with the fiber formation portion. The particulate source is configured to supply a controlled amount of particulate through the particulate supply port to the molten mineral material before the molten mineral material is formed into the solid fibers.

### BRIEF DESCRIPTION OF THE DRAWINGS

Features and advantages of the invention will become apparent from the following detailed description made with reference to the accompanying drawings, wherein:

FIG. 1 is an enlarged partial view of an insulation product formed with mineral fibers having property enhancing inclusions;

FIG. 2 is a schematic view of a fiberizer assembly;

FIG. 3 is a partial cross-sectional schematic view of an exemplary rotary fiberizer assembly;

FIG. 4 is a partial cross-sectional schematic view of another rotary fiberizer assembly, configured for introduction of a particulate additive to the glass delivery tube;

FIG. 5 is a partial cross-sectional schematic view of another rotary fiberizer assembly, configured for introduction of a particulate additive to the spinner through a separate particulate delivery tube;

FIG. 6 is a partial cross-sectional schematic view of another rotary fiberizer assembly, configured for introduction of a particulate additive to the forehearth;

FIG. 7 illustrates the results of infrared absorption testing of the epoxy sample prepared without inclusions, showing absorbance as a function of wavelength;

FIG. 8 illustrates the results of infrared absorption testing of the epoxy sample prepared with 5% volume loaded magnetite nanoparticle inclusions, showing absorbance as a function of wavelength;

FIG. 9 illustrates the infrared absorption test results of FIG. 8 with the absorbance of the epoxy substrate subtracted out within the critical wavelength range of approximately 4-6 μm to approximate the absorbance of the 5% volume particles;

FIG. 10 illustrates the results of infrared absorption testing of an epoxy sample prepared with 1% volume loaded magnetite nanoparticle inclusions, showing absorbance as a function of wavelength; and

FIG. 11 illustrates the infrared absorption test results of FIG. 10 with the absorbance of the epoxy substrate subtracted out within the critical wavelength range of approximately 4-6 μm to approximate the absorbance of 1% volume particles.

### DETAILED DESCRIPTION

This Detailed Description merely describes embodiments of the invention and is not intended to limit the scope of the claims in any way. Indeed, the invention as claimed is broader than and unlimited by the preferred embodiments, and the terms used in the claims have their full ordinary meaning

Also, while the detailed exemplary embodiments described in the specification and illustrated in the drawings relate to a fiberizer assembly for producing glass fibers having thermal resistance or thermal absorption enhancing inclusions for use in a fiberglass insulation product, it should be understood that many of the inventive features described herein may be applied to other types of mineral fibers, non-mineral fibers (e.g., polyester fibers), fibers having other types of property enhancing inclusions, and other products or materials using mineral fibers modified as described in the present application.

The present application contemplates exemplary systems and methods for producing fibers (for example, glass fibers), and the mineral fibers produced, for use in fiber-containing products (e.g., fiberglass batt insulation products) having improved performance characteristics resulting from adaptation or modification of the mineral fibers. In one embodiment, a fiberglass insulation product is provided with increased thermal resistance without significantly increasing the amount of fiberglass material in the product. According to an inventive aspect of the present application, the thermal absorption of an insulation product may be enhanced by providing fibers having particles selected to scatter and/or absorb thermal radiation passing through the glass fibers. While the particles may be added to or adhered to the fibers at any time between production of the glass fibers and formation of the insulation product, in another embodiment, particles are introduced into the molten material before or during fiberization, such that the particles form inclusions in the formed fibers.

Many different types of particulate materials may be used to provide enhanced thermal resistance for a fiberglass insulation product. According to one aspect of the present application, one or more opacifier materials (i.e., materials having refractive indices differing from that of the glass material and/or absorptive indices greater than that of the glass material) may be used to reflect, refract, and/or absorb thermal radiation. In an exemplary embodiment, fibers formed from a glass material having a refractive index n of approximately 1.5 at a wavelength range of 2-7 μm are provided with inclusions formed from particulate having a corresponding refractive index (i.e., at a wavelength range of 2-7 μm) of greater than 1.5, such as, for example, a refractive index greater than 2, or greater than 5. For example, magnetite has a corresponding refractive index of approximately 2, titanium dioxide has a corresponding refractive index of approximately 2 to approximately 2.5, titanium has a corresponding refractive index of approximately 2 to approximately 5, boron nitride has a corresponding refractive index of approximately 2, and iron has a corresponding refractive index of approximately 3.6. As another example, fibers formed from a glass material having an absorption index k of approximately 0 at a wavelength range of 2-7 μm are provided with inclusions formed from particulate having an absorption index of greater than 0, such as, for example, an absorption index greater than 0.3, greater than 1, greater than 4, or greater than 8. For example, magnetite has an absorption index of approximately 0.3 to approximately 0.5 at a wavelength range of 5-7 μm, titanium has an absorption index of approximately 4 to approximately 10 at a wavelength range of 2-7 μm, and iron has an absorption index of approximately 7.9 to approximately 11.4 at a wavelength range of 2-5 μm.

According to an exemplary aspect of the present application, an increase in the total absorption index of the glass fibers from approximately 0 may provide significant reductions in thermal conductivity in the fibers. For example, the presence of boron in glass reduces the thermal conductivity due to its absorption in a small wavelength range near 7 um. Prior testing of boron-containing glass fibers having an absorption index of approximately 0.08 at this peak produced a 16% reduction in thermal conductivity as compared to boron-free glass fibers having an absorption index of approximately 0 in that wavelength range. Higher boron contents reduced the thermal conductivity even further, but to a lesser degree as more boron is added. Boron addition to raise the peak above an absorption index of about 0.3 yielded little further improvement in thermal performance. Accordingly, in exemplary embodiments of the present application, glass fibers are formed using volume loading of particulate in the molten glass material that is sufficient to produce an absorption index of at least 0.01, or at least 0.02, or at least 0.08, or at least 0.10, or between 0.08 and 0.30.

According to another exemplary aspect of the present application, a an exemplary glass fiber forming system may utilize an inclusion-forming particulate having a complex refractive index (n+ik) greater than a complex refractive index of the glass material in the 2 to 7 μm wavelength region.

According to another aspect of the present application, one or more types of particulate may be provided such that at least a portion of the added particulate does not dissolve or melt into the glass melt material. In one embodiment, a particulate may be selected to include a material having a higher melting point than the maximum glass melt temperature in the fiberizing process, and/or that will not dissolve rapidly into the molten glass. In another embodiment, particulate inclusions may be formed by phase separation of the glass into a minor droplet phase within a matrix of a major phase. Use of such materials may ensure that small, discrete inclusions are present within the glass fibers. Exemplary materials for inclusion-forming particulate material include iron, iron oxide (e.g., magnetite), titanium, titanium oxide, silicon, boron nitride, tungsten, and zinc oxide. While the inclusion-forming particles may be provided in a range of sizes, in one example, particles having a diameter of less than approximately 1 μm are provided.

As shown in FIG. 1, an insulation product A may include a plurality of fibers F formed with inclusions i. To maintain structural integrity of the fibers F, the diameter d of the inclusions i may be limited to a predetermined fraction of the diameter D of the fibers F (for example, about one half or less of the diameter D of the fiber F). Alternatively, rather than feeding unaltered particles into the glass melt, larger or more concentrated particulate (e.g., a glass frit containing a high content of iron oxide particulate) may be introduced into the glass melt in a process utilizing a subsequent crushing operation to reduce the larger or more concentrated particulate to particles of a desired smaller size and distribution. Such a procedure may improve rapid incorporation of the particulate into the glass, reducing the amount of particulate escaping into the surrounding environment. As another example, larger particles may be provided to allow for some dissolution of the material prior to fiber formation, forming smaller inclusions in the fibers.

In an exemplary method of producing fibers having property enhancing inclusions, a molten material is supplied to a fiber forming apparatus. A controlled amount of particulate is added to the molten material. The molten material with the added particulate is formed into inclusion-containing fibers, such that the particulate does not dissolve in the molten mineral material.

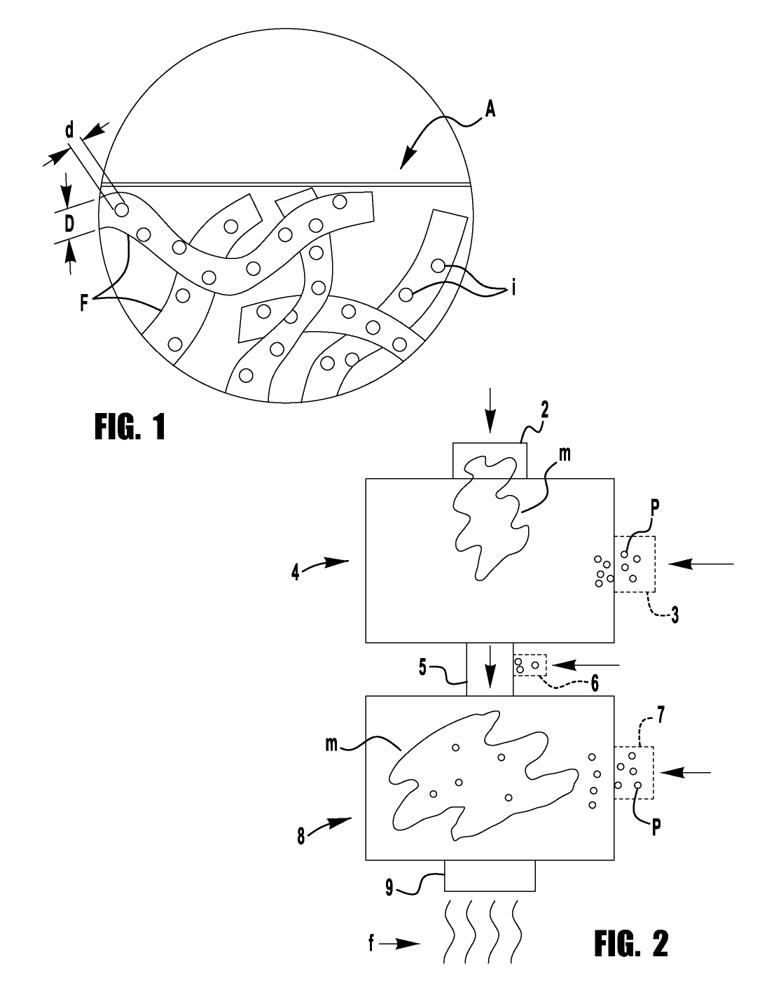

According to an aspect of the present application, a property enhancing particulate may be supplied to a fiberizer or fiber forming apparatus before and/or during fiber formation to cause the formation of property enhancing inclusions in the formed fibers. FIG. 2 schematically illustrates an exemplary fiber forming apparatus 1 including a molten mineral collection portion 4 and a fiber formation portion 8. The mineral material m is supplied to the molten mineral collection portion 4 through an inlet port 2, and is the supplied to the fiber formation portion 8 (for example, through a connecting port 5). The fiber formation portion 8 produces solid fibers f from the molten material m, which exit the apparatus 1 through a fiber dispensing port 9.

The performance enhancing particulate p may be added to the molten material m before and/or during fiber formation in a variety of arrangements. As one example, the particulate p may be added to the molten mineral collection portion 4 with the mineral material m through the inlet port 2. In another example, the particulate p may be added to the molten mineral collection portion 4 through a separate particulate supply port 3 for mixing with the mineral material m within the molten mineral collection portion 4 of the apparatus 1. In still another embodiment, the particulate p may be added to the connecting port 5 between the molten mineral collection portion 4 and the fiber formation portion 8 (for example, through a supply port 6) for entry into the fiber formation portion 8 with the molten mineral material m. In yet another embodiment, the particulate p may be added to the fiber formation portion 8 through a separate particulate supply port 7 for mixing with the molten mineral material m within the fiber formation portion. In still other embodiments, one or more types of particulate may be added to the molten material at multiple locations of the apparatus, for example, in two or more of the ports 2, 3, 6, 7 shown in the exemplary apparatus 1.

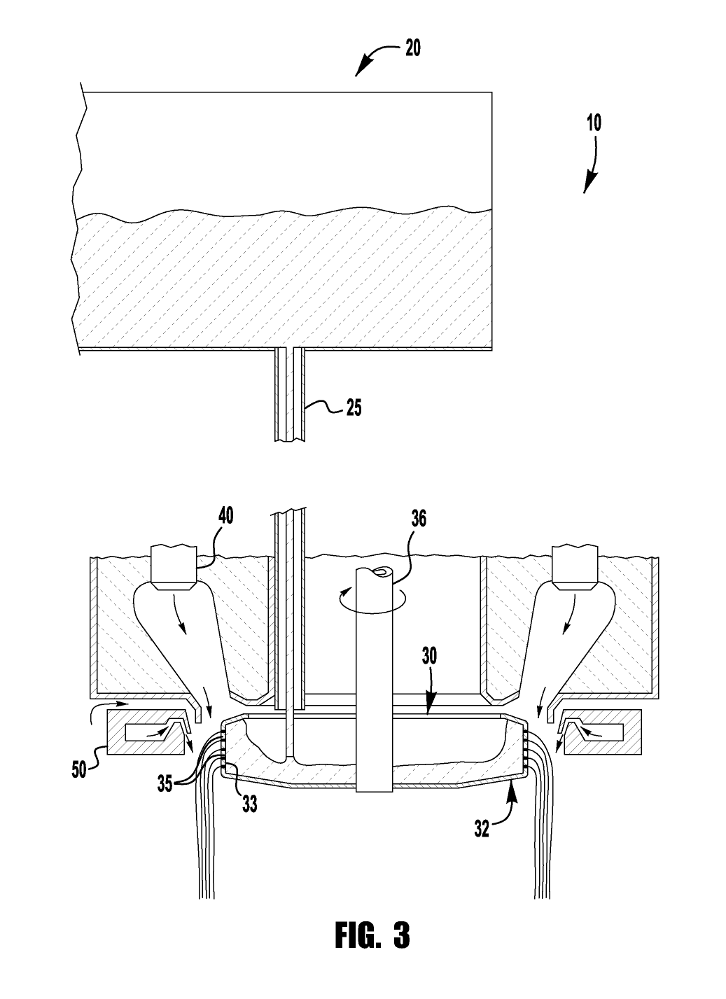

Many different types of fiberizers or fiber formation apparatus may be utilized to form fibers from molten mineral material. As shown in FIG. 3, one system or fiberizer assembly 10 for forming fibers of mineral material, such as glass, utilizes a rotary process in which molten glass is supplied from a forehearth 20 through a vertical glass delivery tube 25 into a rotating centrifuge or spinner 30, rotating on spindle 36. The molten glass flows across the spinner bottom wall 32 to the spinner peripheral wall 33 and passes in a molten state through the orifices 35 of the spinner peripheral wall to create glass fibers. A burner 40 directs hot gases toward the peripheral wall 33 to maintain primary fibers in a soft, attenuable condition, for attenuation into thin, secondary fibers by an annular blower 50 surrounding the spinner 30.

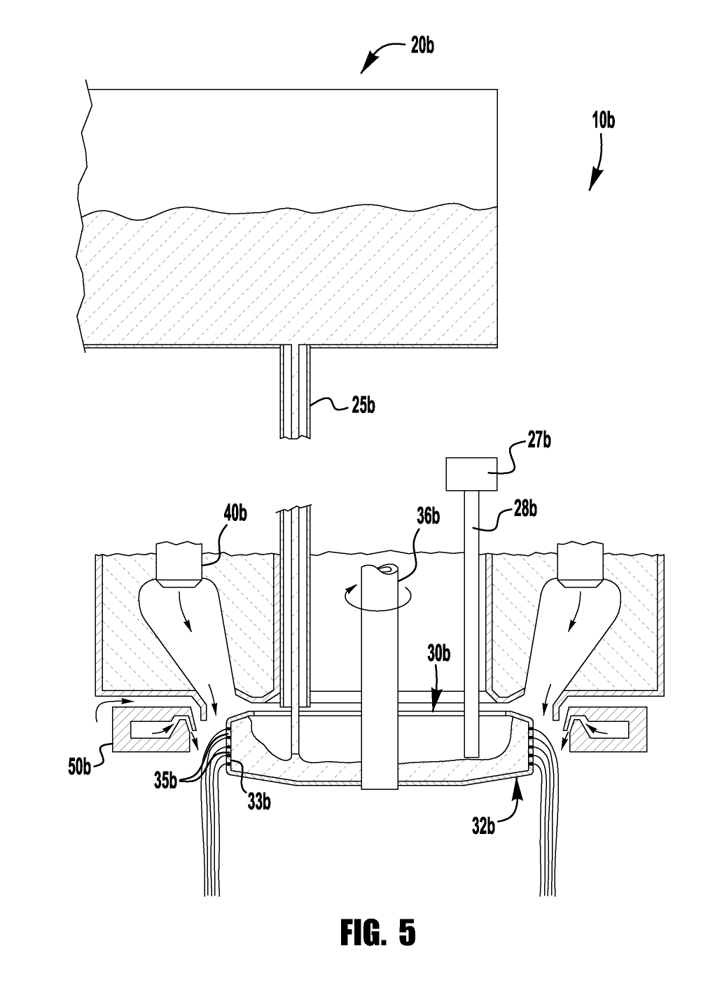

The present application contemplates introduction of inclusion forming particles at one or more locations within a glass fiber forming system. The particulate may be supplied through a supply port (e.g., a tube, valve, fitting, or other fluid system component), at one or more locations in the fiberizer assembly, such that a controlled amount of the particulate is added to, and dispersed within, molten glass before or during fiberization, to promote the formation of thermal resistance enhancing inclusions within the glass fibers. To control the supply of particulate into the glass stream, a vibratory feeder, screw feeder, or other such metering device may be utilized (for example, as shown schematically in FIG. 5 at reference 27b).

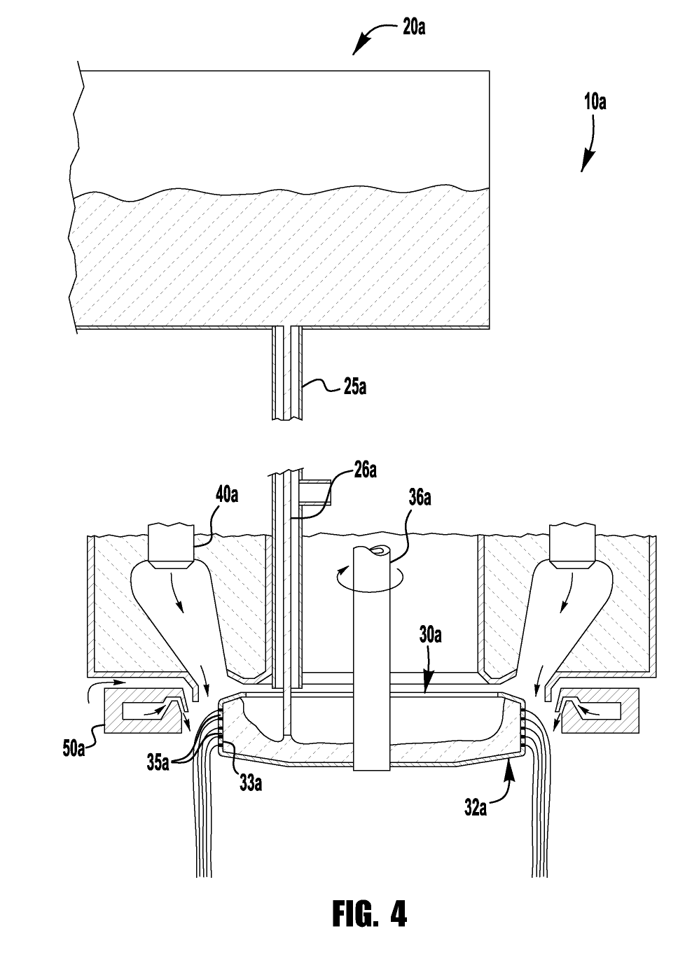

As one example, shown in FIG. 4, particulate may be supplied to the glass delivery tube 25a, for example, through a supply port 26a, such that the molten glass carries the particulate into the spinner to mix the particulate within the molten glass for even distribution of the particulate. To minimize the amount of particulate that escapes from the fiberizer assembly and is released into the surrounding area, the glass delivery tube 25a may be extended further into the spinner 30a.

As another example, shown in FIG. 5, the fiberizer assembly 10b may include a separate or independent vertical particulate delivery tube 28b for supplying the particulate directly into the spinner 30b for mixing with the molten glass at the bottom of the spinner. To minimize the amount of particulate escaping from the fiberizer and released into the surrounding area, the particulate delivery tube 28b may be positioned to extend well into the spinner 30b, terminating just above the molten glass accumulated at the bottom of the spinner 30b.

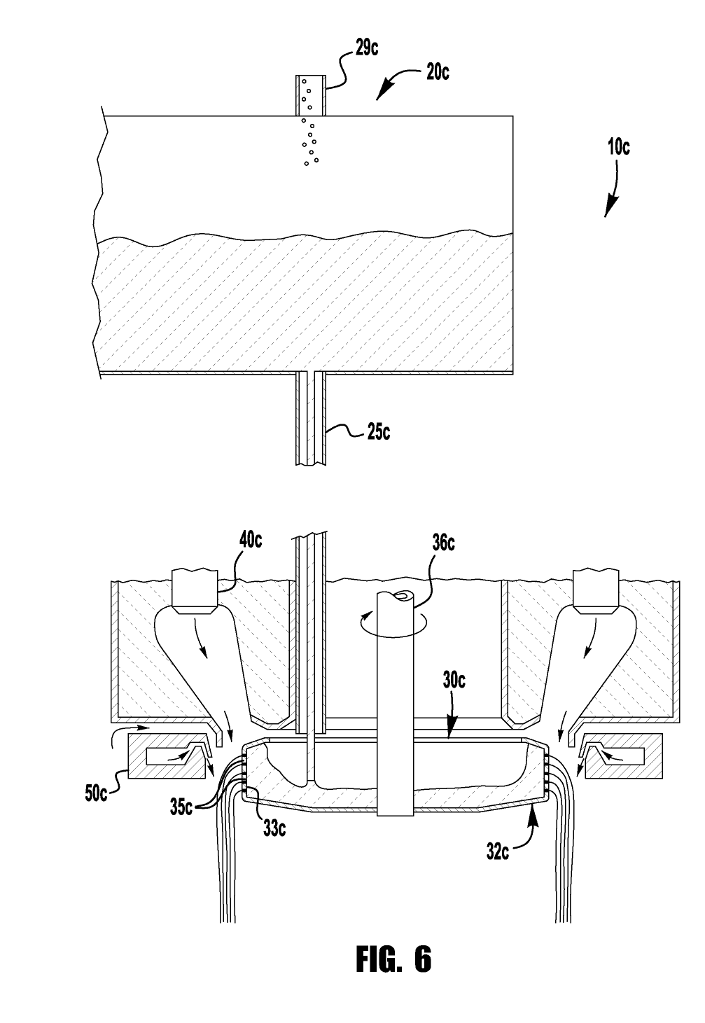

In yet another example, shown in FIG. 6, particulate may be supplied to the molten glass within the forehearth 20c, for example, by extending a supply tube 29c into the forehearth proximate to the bushing well, just above the bushing (not shown), to ensure collection of the particulate into the bushing and to minimize exposure time of the particulate to the high molten glass temperatures present in the forehearth.

Where the material to be fiberized has a high melt temperature, such as glass, it may be desirable to introduce the opacifying particles at a location in which the molten material has had an opportunity to cool, while remaining in molten form, to prevent the particles from melting or dissolving into the molten material. Particles with higher melting temperatures and/or greater resistance to dissolving may additionally or alternatively be used.

### EXAMPLE

To determine the effect on thermal resistance of opacifier inclusions dispersed in a solidified molten material, infrared (IR) absorption testing was performed on samples of an epoxy material within which 20-30 nm magnetite (Fe₃O₄) nanoparticles had been dispersed while the epoxy was in molten form. The use of an epoxy rather than glass was a convenient screening tool (e.g., to test the viability of the particulate in enhancing absorption) which allowed for convenient and safe preparation of the samples at much lower temperatures. Three types of samples were prepared: (1) epoxy material without nanoparticles; (2) epoxy material with 5% by volume magnetite nanoparticles, and epoxy material with 1% by volume magnetite nanoparticles.

To prepare epoxy samples with and without the inclusions, the three types of molten epoxy sample materials were each applied to a low density polyethylene (LDPE) sheet (e.g., SARAN WRAP®), and a second LDPE sheet was applied to sandwich the epoxy sample. The sandwiched epoxy samples were rolled to a substantially uniform thickness of approximately 42 μm. After the samples were given sufficient time to cure, the LDPE sheets were peeled away from the epoxy samples.

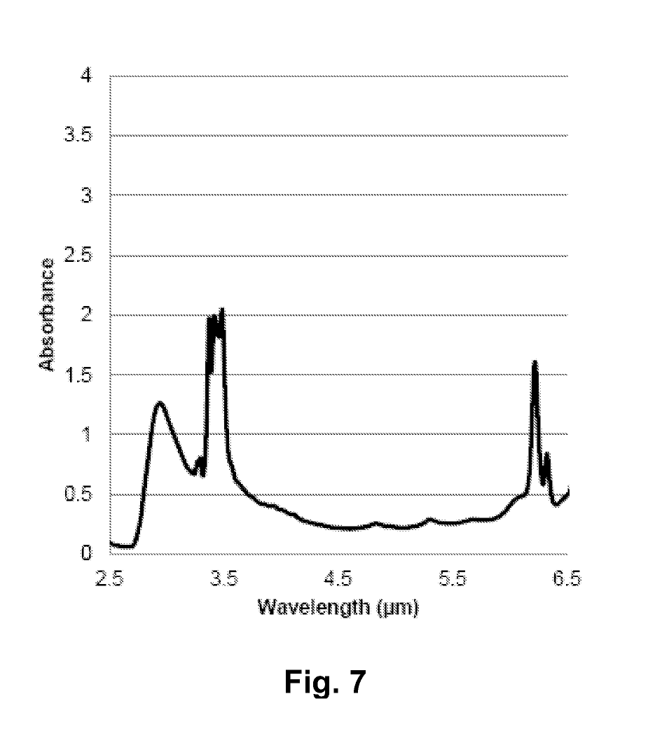

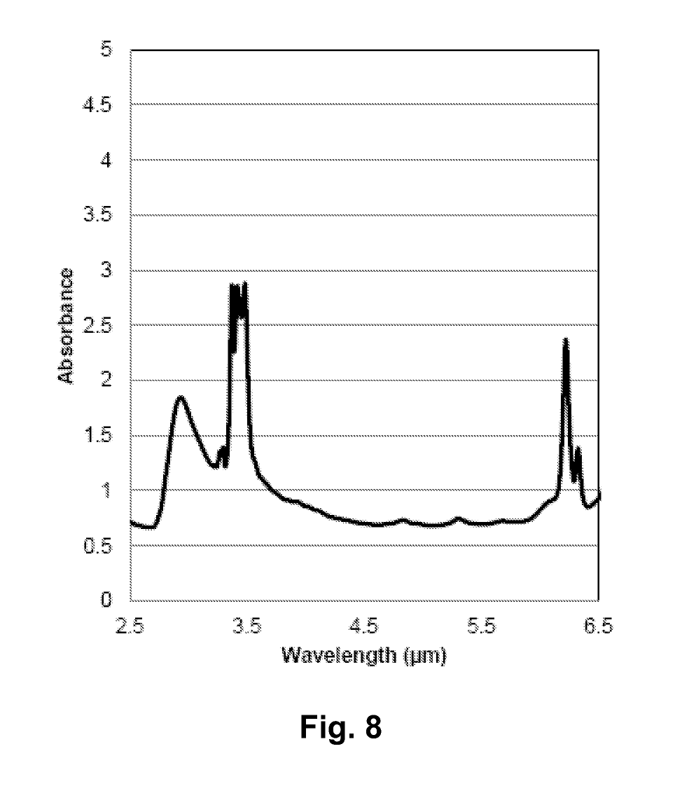

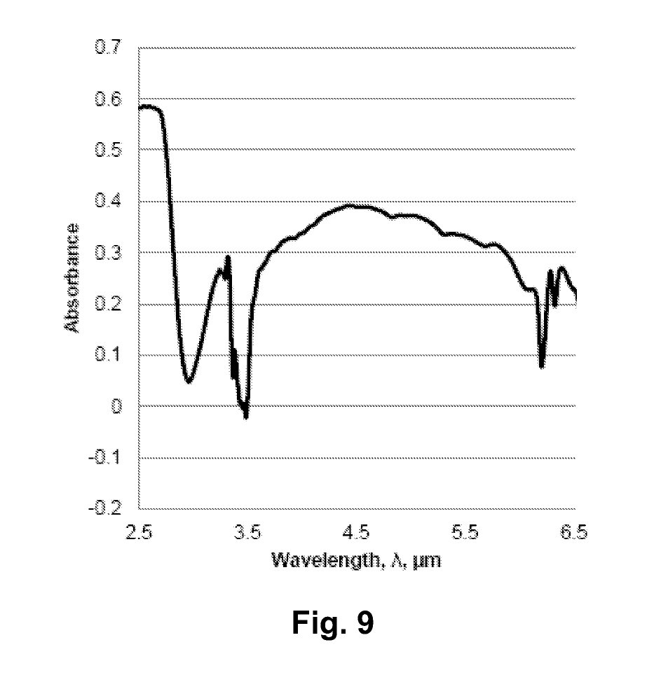

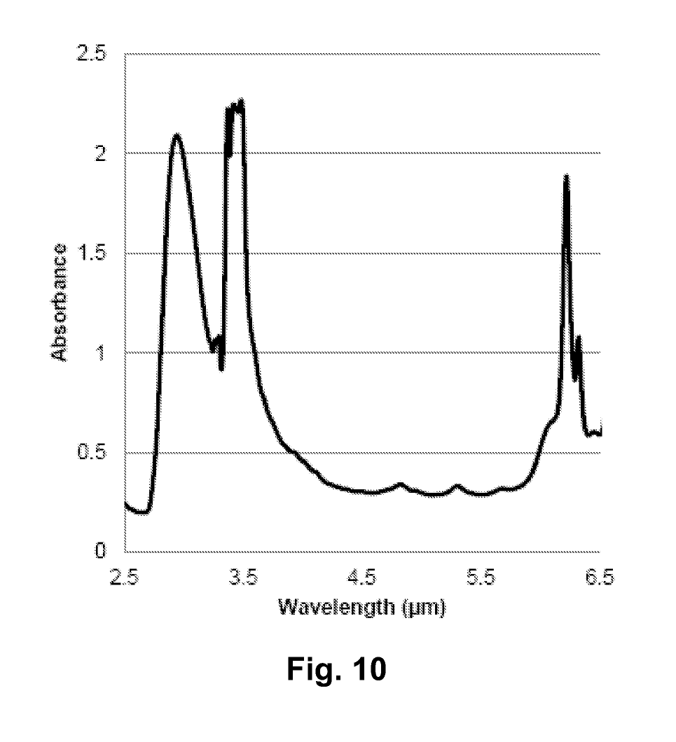

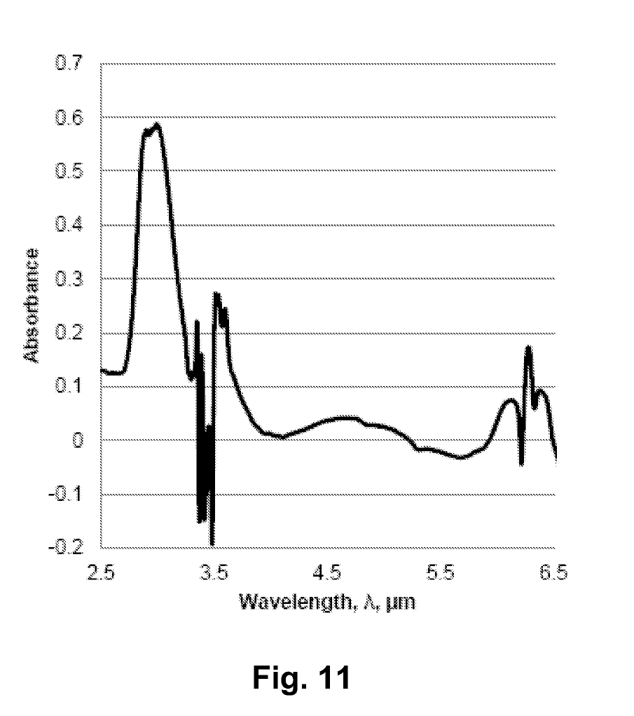

IR absorption testing was performed on the samples, and the absorbance, A, was measured in the wavelength region 2-7 μm for the inclusion-free samples (FIG. 7), the 5% volume loaded samples (FIG. 8), and the 1% volume loaded samples (FIG. 10). This wavelength region was chosen as a region important in radiative heat transfer through silicate glass fiber insulation. At shorter wavelengths, the room temperature blackbody radiation is of small intensity with very little heat transferred radiatively. At longer wavelengths, silicate glasses already absorb strongly. Spikes in absorbance near 2, 3.5, and 6.3 μm are attributable to hydroxides and hydrocarbons in the epoxy. Corresponding spikes are also present in the difference spectra (FIGS. 9 and 11) due to the inability of the spectral subtraction procedure to quantitatively remove the epoxy spectral features across the entire spectrum. The spectral region of interest is thus the narrower wavelength range of approximately 4-6 μm. The absorbance of the samples without particles was then subtracted from the absorption coefficients of the samples with 5% volume loaded particles and 1% volume loaded particles to determine the effect on absorbance of the particles.

The effect on absorbance of the particles in the 5% volume loaded samples (shown in FIG. 8) was significant, providing an increase in absorbance of 0.3 to 0.4 over the 0.2 to 0.3 values of the epoxy samples without particles (as shown in FIG. 9). Similar absorbance enhancement should be expected for the same inclusions in other carrier materials, including fiberglass. In the 1% volume loaded samples, only minimal increases in absorbance over the inclusion free samples were noted (shown in FIG. 11).

When viewing the samples with particles using optical microscopy, larger agglomerated particles (mostly 5-15 μm in diameter) were observed in the samples. This agglomeration may be attributable to the magnetic nature of the nanoparticles and/or incomplete surface wetting by the epoxy. The agglomeration, which results in portions of the material that are void of inclusions, is believed to reduce the improvements in absorption provided by the particle inclusions. Mechanical methods (e.g., stirring) and chemical methods (dispersive coatings on the particles) may be used to reduce agglomeration and further increase enhancements to material absorption.

While the present invention has been illustrated by the description of embodiments thereof, and while the embodiments have been described in considerable detail, it is not the intention of the applicants to restrict or in any way limit the scope of the invention to such details. Additional advantages and modifications will readily appear to those skilled in the art. Therefore, the inventive concept, in its broader aspects, is not limited to the specific details, the representative apparatus, and illustrative examples shown and described. Accordingly, departures may be made from such details without departing from the spirit or scope of the applicant's general inventive concept.

While various inventive aspects, concepts and features of the inventions may be described and illustrated herein as embodied in combination in the exemplary embodiments, these various aspects, concepts and features may be used in many alternative embodiments, either individually or in various combinations and sub-combinations thereof. Unless expressly excluded herein all such combinations and sub-combinations are intended to be within the scope of the present inventions. Still further, while various alternative embodiments as to the various aspects, concepts and features of the inventions--such as alternative materials, structures, configurations, methods, devices and components, alternatives as to form, fit and function, and so on—may be described herein, such descriptions are not intended to be a complete or exhaustive list of available alternative embodiments, whether presently known or later developed. Those skilled in the art may readily adopt one or more of the inventive aspects, concepts or features into additional embodiments and uses within the scope of the present inventions even if such embodiments are not expressly disclosed herein. Additionally, even though some features, concepts or aspects of the inventions may be described herein as being a preferred arrangement or method, such description is not intended to suggest that such feature is required or necessary unless expressly so stated. Still further, exemplary or representative values and ranges may be included to assist in understanding the present disclosure, however, such values and ranges are not to be construed in a limiting sense and are intended to be critical values or ranges only if so expressly stated. Moreover, while various aspects, features and concepts may be expressly identified herein as being inventive or forming part of an invention, such identification is not intended to be exclusive, but rather there may be inventive aspects, concepts and features that are fully described herein without being expressly identified as such or as part of a specific invention, the inventions instead being set forth in the appended claims. Descriptions of exemplary methods or processes are not limited to inclusion of all steps as being required in all cases, nor is the order that the steps are presented to be construed as required or necessary unless expressly so stated.

1. A method of producing fibers having property enhancing inclusions, the method comprising:
supplying a molten material to a fiber forming apparatus;
adding a controlled amount of particulate to the molten material; and
forming the molten material with the added particulate into fibers, such that an undissolved portion of the added particulate forms inclusions in the fibers, the inclusions having an absorption index in a 2-7 μm wavelength region that is greater than a corresponding absorption index of the material.

2. The method of claim 1, wherein the particulate comprises at least one of iron, iron oxide, titanium, titanium oxide, silicon, tungsten, zinc oxide, and boron nitride.

3. The method of claim 1, wherein the particulate comprises particles having a maximum diameter of approximately 1 μm.

4. The method of claim 1, wherein the particulate comprises an opacifier.

5. The method of claim 1, wherein adding the controlled amount of particulate to the molten material comprises supplying the particulate using at least one of a vibratory feeder and a screw feeder.

6. The method of claim 1, wherein adding the controlled amount of particulate to the molten mineral material comprises supplying the particulate through a port connected with a mineral delivery tube.

7. The method of claim 1, wherein adding the controlled amount of particulate to the molten mineral material comprises supplying the particulate through a vertical particulate delivery tube terminating within a fiber formation portion of the fiber forming apparatus.

8. The method of claim 1, wherein adding the controlled amount of particulate to the molten mineral material comprises supplying the particulate through a port connected with a forehearth, the forehearth supplying the molten mineral material to a fiber formation portion of the fiber forming apparatus.

9. The method of claim 1, wherein the fiber forming apparatus comprises a rotary fiberizer having a spinner for centrifuging the mineral material through orifices in a peripheral wall of the spinner.

10. The method of claim 1, wherein the particulate comprises a material having a melting temperature that is greater than a temperature of the molten mineral material when the particulate is added to the molten mineral material.

11. The method of claim 1, wherein the particulate has a refractive index in the 2-7 μm wavelength region that is greater than a corresponding refractive index of the material.

12. A glass fiber suitable for insulation, the glass fiber comprising a glass material and a plurality of inclusions within the glass material, the plurality of inclusions having an absorption index in a 2-7 μm wavelength region that is greater than a corresponding absorption index of the glass material.

13. The glass fiber of claim 11, wherein the plurality of inclusions comprises at least one of iron, iron oxide, titanium, titanium oxide, silicon, tungsten, zinc oxide, and boron nitride.

14. The glass fiber of claim 11, wherein the plurality of inclusions each have a maximum diameter of approximately 1 μm.

15. The glass fiber of claim 11, wherein the plurality of inclusions have a refractive index in the 2-7 μm wavelength region that is greater than a corresponding refractive index of the material.

16. A fiberglass insulation product comprising:
a plurality of glass fibers comprising a glass material and a plurality of inclusions within the glass material, wherein the plurality of inclusions have an absorption index in a 2-7 μm wavelength region that is greater than a corresponding absorption index of the glass material;
wherein the fiberglass insulation product has a thermal resistance greater than a thermal resistance of a comparable fiberglass insulation product produced with glass fibers formed without the plurality of inclusions.

17. The fiberglass insulation product of claim 16, wherein the plurality of inclusions comprise at least one of iron, iron oxide, titanium, titanium oxide, silicon, tungsten, zinc oxide, and boron nitride.

18. A fiberizer assembly comprising:
a spinner having an orificed peripheral wall through which molten mineral material passes to form mineral fibers;
a forehearth supplying molten material to the spinner through a delivery tube;
a burner positioned to direct hot gases toward the peripheral wall;
a blower positioned to attenuate fiber materials exiting orifices in the peripheral wall;
a particulate source retaining particles having a maximum diameter of approximately 1 μm; and
a particulate supply port connected with the particulate source and configured to supply a controlled amount of the particles to the molten material before the molten material passes through the peripheral wall orifices.

19. The fiberizer assembly of claim 18, wherein the particulate supply port is connected with the delivery tube.

20. The fiberizer assembly of claim 18, wherein the particulate supply port comprises a vertical particulate delivery tube terminating within the spinner.

21. The fiberizer assembly of claim 18, wherein the particulate supply port is connected with the forehearth.

22. The fiberizer assembly of claim 18, further comprising at least one of a vibratory feeder and a screw feeder for controlled supply of particulate into the molten material.

23. A fiber forming apparatus comprising:
a molten mineral collection portion configured to receive a molten mineral material;
a fiber formation portion connected with the molten mineral collection portion and configured to produce solid fibers from the molten mineral material;
a fiber dispensing port in communication with the fiber formation portion;
a particulate source retaining particles having a maximum diameter of approximately 1 μm; and
a particulate supply port connected with the particulate source and configured to supply a controlled amount of particulate to the molten mineral material before the molten mineral material is formed into the solid fibers.
